(19) United States
(12) Patent Application Publication
(10) Pub. No.: US 2026/0104548 A1
(43) Pub. Date: Apr. 16, 2026

(54) POWER SPLITTERS

(71) Applicant: CORNING INCORPORATED, CORNING, NY (US)

(72) Inventors: John David Downie, Painted Post, NY (US); Yongmin Jung, Southampton (GB); Sijing Liang, Southampton (GB)

(21) Appl. No.: 19/357,865

(22) Filed: Oct. 14, 2025

Related U.S. Application Data
(60) Provisional application No. 63/707,868, filed on Oct. 16, 2024.

(51) Int. Cl. G02B 6/28

(52) U.S. Cl. CPC G02B 6/2821

(57) ABSTRACT

A power splitter may include a single-core optical fiber, a beam-splitting optical fiber, and a multicore optical fiber. The beam-splitting optical fiber may include a polygonal core configured to output a multimode interference beam pattern including a plurality of beam spots, an input end coupled to the single-core optical fiber, and an output end coupled to the multicore optical fiber. In embodiments, a difference between a mode field diameter of the cores of the multicore optical fiber and a mode field diameter of the core of the single-core optical fiber may be less than or equal to 50%. In embodiments, when the power splitter is in operation, a difference between a distance between neighboring beam spots of the multimode interference beam pattern output by the beam-splitting optical fiber and a core pitch of the cores of the multicore optical fiber may be less than or equal to 10%.

This application claims the benefit of priority under 35 U.S.C. § 119 of U.S. Provisional Application Ser. No. 63/707,868 filed on Oct. 16, 2024, the content of which is relied upon and incorporated herein by reference in its entirety.

### FIELD

The present disclosure generally relates to power splitters, and, more specifically, to single-core optical fiber to multicore optical fiber power splitters utilizing a fiber having a core of polygonal shape for efficient and uniform power distribution, and to methods of making the same.

### BACKGROUND

Multicore optical fiber technology is a promising technology for future submarine communication systems that can enable petabit-rate cable capacity by means of space division multiplexing while maintaining current cable designs. In the context of submarine optical communication, where electrical power supply to long-haul cables is constrained, power-efficient multicore optical fiber amplifiers and multicore optical fiber components, such as power splitters, are crucial for realizing functional multicore optical fiber-based optical networks. Accordingly, a need exists for efficient multicore optical fiber amplifiers and components, including power splitters.

### SUMMARY

The present disclosure includes energy-efficient power splitters for distributing optical power from a single-core optical fiber to a multicore optical fiber, thereby facilitating pump laser light distribution in amplifiers, such as multicore fiber amplifiers. The power splitters described herein offer compatibility with existing pump farming/sharing technologies, such as those utilized in submarine cable repeaters, while simplifying the construction of pump farming/sharing architectures.

In embodiments, a power splitter may include a single-core optical fiber, a beam-splitting optical fiber, a graded-index optical fiber, a coreless optical fiber, and a multicore optical fiber. The single-core optical fiber may include a core, an input end, and an output end.

The beam-splitting optical fiber may include a polygonal core configured to output a multimode interference beam pattern including a plurality of beam spots, an input end coupled to the output end of the single-core optical fiber, and an output end. The graded-index optical fiber may include a graded-index core, an input end, and an output end. The coreless optical fiber may include an input end, and an output end. The multicore optical fiber may include a plurality of cores, an input end, and an output end.

In embodiments, the input end of one of the graded-index optical fiber or the coreless optical fiber may be coupled to the output end of the beam-splitting optical fiber, the output end of the other one of the graded-index optical fiber or the coreless optical fiber may be coupled to the input end of the multicore optical fiber, and the graded-index optical fiber and the coreless optical fiber may be configured for outputting a multimode interference beam pattern including a plurality of beam spots. In embodiments, when the power splitter is in operation, a distance between neighboring beam spots of the multimode interference beam pattern output by the beam-splitting optical fiber may be different from a distance between neighboring beam spots of the multimode interference beam pattern output by the graded-index optical fiber and the coreless optical fiber.

In embodiments, a power splitter, may include a single-core optical fiber, a beam-splitting optical fiber, and a multicore optical fiber. In embodiments, the single-core optical fiber may include a core, an input end, and an output end. The beam-splitting optical fiber may include a polygonal core configured to output a multimode interference beam pattern having a plurality of beam spots, an input end coupled to the output end of the single-core optical fiber, and an output end. The multicore optical fiber may include a plurality of cores, an input end coupled to the output end of the beam-splitting optical fiber, and an output end. In embodiments, the power splitter may be configured such that at least one of the following may be satisfied: a difference between a mode field diameter of the plurality of cores of the multicore optical fiber and a mode field diameter of the core of the single-core optical fiber may be less than or equal to 50%; or when the power splitter is in operation, a difference between a distance between neighboring beam spots of the multimode interference beam pattern output by the beam-splitting optical fiber and a core pitch of the plurality of cores of the multicore optical fiber may be less than or equal to 10%. In embodiments, when the power splitter is in operation, the power splitter may further exhibit at least one of the following: an insertion loss of the power splitter may be less than or equal to 1 dB; or a power distribution variance among the plurality of cores of the multicore optical fiber may be less than or equal to 10%.

In embodiments, a repeater may include a plurality of pump lasers, a coupler network configured for routing power from at least one of the plurality of pump lasers to at least one power splitter described herein, and at least one power amplifier coupled to the at least one power splitter. In embodiments, the at least one power amplifier may include a doped multicore fiber amplifier.

Additional features and advantages of the power splitters described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 illustrates an exemplary power splitter.

FIG. 2 schematically illustrates a side view of an exemplary power splitter.

FIGS. 3A-3D schematically illustrate the all-fiber construction of an exemplary power splitter.

FIGS. 4A and 4B show simulated beam propagation from an input single-core optical fiber to an output multicore optical fiber of an exemplary power splitter.

FIG. 5 shows various multibeam patterns generated at different locations along a beam-splitting optical fiber of an exemplary power splitter.

FIG. 6 shows a calculated transverse field profile output by an exemplary square-core, beam-splitting optical fiber.

FIG. 7 shows simulated transmission loss as a function of core pitch.

FIG. 8 schematically illustrates another exemplary power splitter.

FIG. 9 schematically illustrates another exemplary power splitter.

FIG. 10 schematically illustrates another exemplary power splitter.

FIG. 11 plots a relative refractive index profile of an exemplary graded-index optical fiber.

FIG. 12 schematically illustrates an exemplary transmission system incorporating the power splitters described herein with pump farming/sharing.

FIG. 13 schematically illustrates another exemplary transmission system incorporating the power splitters described herein with pump farming/sharing.

FIG. 14 schematically illustrates further exemplary transmission system incorporating the power splitters described herein with pump farming/sharing.

FIG. 15A is a CCD (charge-coupled device) image showing the multimode interference beam pattern at the output end of an exemplary beam-splitting optical fiber.

FIG. 15B is a CCD image showing the output beams at the output end of the multicore optical fiber of an exemplary power splitter.

FIG. 16 plots transmission loss of exemplary power splitters as a function of fiber length of an exemplary beam-splitting optical fiber.

FIG. 17 is a microscopic image of a fabricated power splitter.

FIG. 18 plots transmission loss of exemplary power splitters as a function of core pitch of multicore optical fibers.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure. The claims as set forth below are incorporated into and constitute part of this Detailed Description.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

In this specification and in the claims which follow, reference will be made to a number of terms which shall be defined to have the following meanings:

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the end-points of each of the ranges are significant both in relation to the other end-point, and independently of the other end-point.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

### Overview

Described herein is a high-efficiency, low-loss power splitter designed to evenly distribute optical power from a single-core optical fiber to each core of a multicore optical fiber. The power splitter described herein leverages the multimode interference effect within a beam-splitting optical fiber having a polygonal-shaped core, producing distinct multi-beam spots aligned with the core arrangement of the output multicore optical fiber.

The power splitter described herein may further incorporate a graded-index fiber lens and a spacer that enhances the adaptability of the power splitter described herein to a wide range of multicore optical fiber configurations while minimizing loss. The integration of a graded-index optical fiber in conjunction with a coreless fiber may eliminate the stringent requirement for matching specific pairs of input single-core optical fibers and output multicore optical fibers. The combination of the graded-index optical fiber and the coreless optical fiber enables magnification or demagnification of the distance between neighboring imaging beams output from the beam-splitting optical fiber, thereby ensuring compatibility with a wider range of core pitch values of the multicore optical fiber and enhancing the versatility and applicability of the power splitter described herein.

The power splitter described herein provides an effective design for distributing light from a single-core optical fiber to a multicore optical fiber, offering an all-fiber approach for pump light splitting and distribution in multicore fiber amplifiers. This distribution plays a pivotal role in the development of energy efficient multicore fiber amplifiers, holding great promise for the future of optical communication systems. Notably, the power splitter described herein seamlessly integrates with existing pump farming/sharing technology, contributing to the advancement of, e.g., submarine optical systems, while aligning with global carbon neutrality objectives. The power splitter described herein simplifies the construction of efficient pump configurations in multicore fiber amplifiers. Its versatility can extend beyond submarine networks, finding practical applications in the fields of fiber lasers and sensing technology. This adaptability underscores its significant impact across various industries.

### Power Splitter

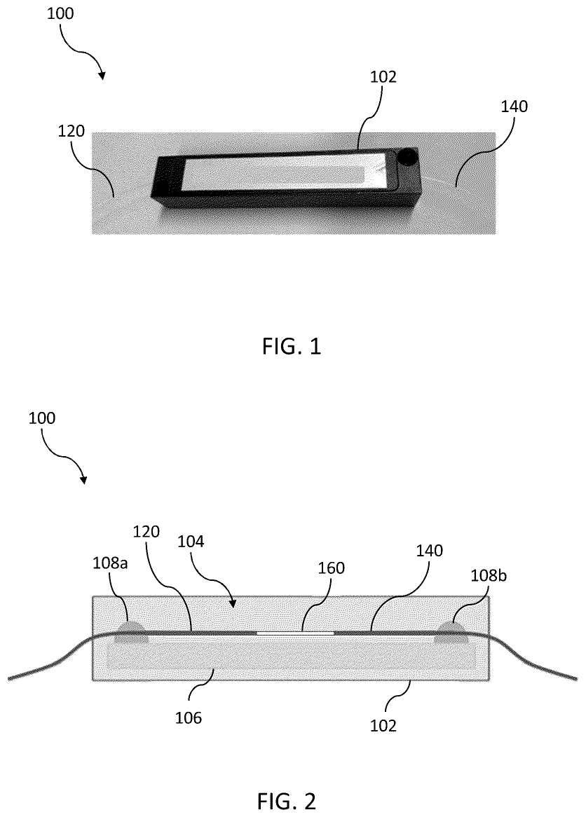

FIG. 1 illustrates an exemplary power splitter 100. FIG. 2 schematically illustrates a side view of the power splitter 100. In embodiments, the power splitter 100 may include a housing 102 defining a housing compartment 104. In FIG. 2, a portion of the housing 102 is removed from the view such that the internal structures of the power splitter 100 can be shown.

In embodiments, the power splitter 100 may include an input, single-core optical fiber 120, an output, multicore optical fiber 140, and a beam-splitting optical fiber 160 disposed between the single-core optical fiber 120 and the multicore optical fiber 140. The single-core optical fiber 120 may be coupled to one end of the beam-splitting optical fiber 160, e.g., via splicing, inside the housing compartment 104, and the multicore optical fiber 140 may be coupled to the opposite end of the beam-splitting optical fiber 160, e.g., via splicing. A portion of the single-core optical fiber 120 may extend from a first end of the housing 102 outside the housing compartment 104, and a portion of the multicore optical fiber 140 may extend from a second end opposite the first end of the housing 102 outside the housing compartment 104.

Referring to FIG. 2, the power splitter 100 may further include a base 106. In embodiments, the base 106 may be secured to the housing 102 such that the base 106 and the housing 102 may not move relative to each other. In embodiments, the base 106 may be formed as an integral portion of the housing 102. In embodiments, the single-core optical fiber 120 may be coupled to the base 106 via a first coupling member 108a, and the multicore optical fiber 140 may be coupled to the base 106 via a second coupling member 108b. In embodiments, the beam-splitting optical fiber 160 may not be directly coupled to the base 106, but may be indirectly coupled to the base 106 and/or housing 102 via the coupling between the base 106 and the single-core optical fiber 120 and/or the multicore optical fiber 140. Thus, the beam-splitting optical fiber 160 may be suspended in air inside the housing compartment 104. In embodiments, the beam-splitting optical fiber 160 may be directly coupled to the base 106 and/or housing 102 via a coupling member. In embodiments, the coupling members 108a, 108b may include adhesives, including but not limited to UV-curable polymers, tapes, fasteners, clamps, or any other suitable techniques or mechanisms for coupling the single-core optical fiber 120 and/or the multicore optical fiber 140 to the base 106.

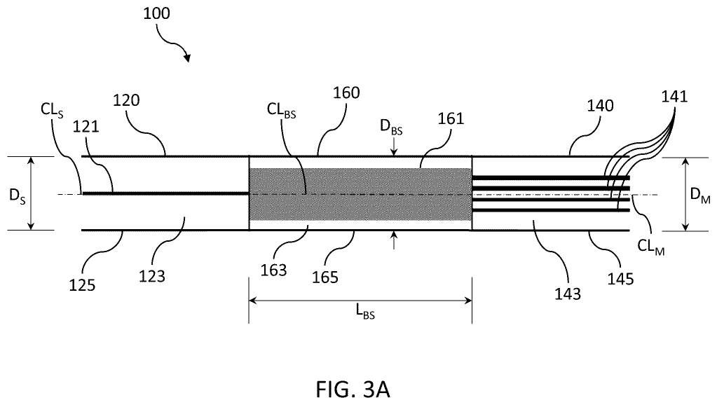

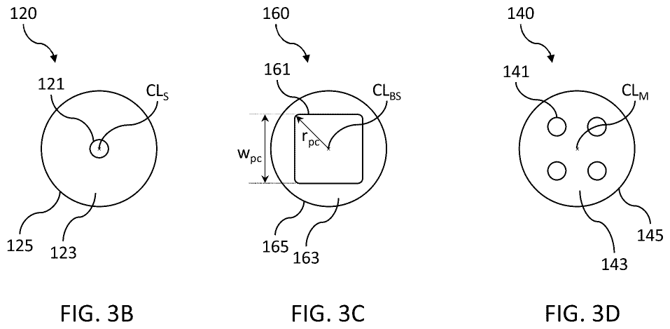

FIG. 3A is another schematic illustration of the power splitter 100 with the housing 102, the base 106, and the coupling members 108a, 108b removed to illustrate the single-core optical fiber 120, the multicore optical fiber 140, and the beam-splitting optical fiber 160 of the power splitter 100 in greater detail. FIGS. 3B, 3C, and 3D are schematic illustrations of cross sections of the single-core optical fiber 120, the beam-splitting optical fiber 160, and the multicore optical fiber 140, respectively.

### Single-Core Optical Fiber

As shown in FIGS. 3A and 3B, the single-core optical fiber 120 may include a glass fiber 125 having a fiber axis or centerline CLs and a single core or waveguide 121 disposed in a cladding 123 along the fiber axis CLs. The centerline of the core 121 may overlap and align with the fiber axis CLs of the single-core optical fiber 120. In embodiments, the single-core optical fiber 120 may be a single mode optical fiber. When coupled to a pump laser, the single mode operation of the single-core optical fiber 120 may require less pump laser power as compared to multimode pumping schemes. In embodiments, the single-core optical fiber 120 may be a multimode optical fiber.

The cladding 123 of the single-core optical fiber 120 may have a cladding diameter D_{S}. In embodiments, the cladding diameter D_{S} of the single-core optical fiber 120 may be greater than or equal to (i.e., ≥) 60 μm and less than or equal to (i.e., ≤) 400 μm—including all sub-ranges or values therebetween. For example, in embodiments, the cladding diameter D_{S} of the single-core optical fiber 120 may be ≥60 μm and ≤400 μm, ≥60 μm and ≤350 μm, ≥60 μm and ≤300 μm, ≥60 μm and ≤250 μm, ≥60 μm and ≤200 μm, ≥60 μm and ≤150 μm, ≥60 μm and ≤100 μm, ≥100 μm and ≤400 μm, ≥100 μm and ≤350 μm, ≥100 μm and ≤300 μm, ≥100 μm and ≤250 μm, ≥100 μm and ≤200 μm, ≥100 μm and ≤150 μm, ≥150 μm and ≤400 μm, ≥150 μm and ≤350 μm, ≥150 μm and ≤300 μm, ≥150 μm and ≤250 μm, ≥150 μm and ≤200 μm, ≥200 μm and ≤400 μm, ≥200 μm and ≤350 μm, ≥200 μm and ≤300 μm, ≥200 μm and ≤250 μm, ≥250 μm and ≤400 μm, ≥250 μm and ≤350 μm, ≥250 μm and ≤300 μm, ≥300 μm and ≤400 μm, ≥300 μm and ≤350 μm, or ≥350 μm and ≤400 μm. In embodiments, the cladding diameter D_{S} of the single-core optical fiber 120 may be greater than or equal to (i.e., ≥) 60 μm, ≥70 μm, ≥80 μm, ≥90 μm, ≥100 μm, ≥110 μm, ≥120 μm, ≥130 μm, ≥140 μm, ≥150 μm, ≥160 μm, ≥170 μm, ≥180 μm, ≥190 μm, ≥200 μm, ≥210 μm, ≥220 μm, ≥230 μm, ≥240 μm, ≥250 μm, ≥260 μm, ≥270 μm, ≥280 μm, ≥290 μm, ≥300 μm, ≥310 μm, ≥320 μm, ≥330 μm, ≥340 μm, ≥350 μm, ≥360 μm, ≥370 μm, ≥380 μm, ≥390 μm, or greater. In embodiments, the cladding diameter D_{S} of the single-core optical fiber 120 may be less than or equal to (i.e., ≤) 400 μm, ≤390 μm, ≤380 μm, ≤370 μm, ≤360 μm, ≤350 μm, ≤340 μm, ≤330 μm, ≤320 μm, ≤310 μm, ≤300 μm, ≤290 μm, ≤280 μm, ≤270 μm, ≤260 μm, ≤250 μm, ≤240 μm, ≤230 μm, ≤220 μm, ≤210 μm, ≤200 μm, ≤190 μm, ≤180 μm, ≤170 μm, ≤160 μm, ≤150 μm, ≤140 μm, ≤130 μm, ≤120 μm, ≤110 μm, ≤100 μm, ≤90 μm, ≤80 μm, ≤70 μm, or less.

In embodiments, a diameter of the single core 121 may be greater than or equal to (i.e., ≥) 2 μm and less than or equal to (i.e., ≤) 30 μm-including all sub-ranges or values therebetween. For example, in embodiments, the diameter of the single core 121 may be ≥2 μm and ≤30 μm, ≥2 μm and ≤25 μm, ≥2 μm and ≤20 μm, ≥2 μm and ≤15 μm, ≥2 μm and ≤10 μm, ≥2 μm and ≤5 μm, ≥5 μm and ≤30 μm, ≥5 μm and ≤25 μm, ≥5 μm and ≤20 μm, ≥5 μm and ≤15 μm, ≥5 μm and ≤10 μm, ≥10 μm and ≤30 μm, ≥10 μm and ≤25 μm, ≥10 μm and ≤20 μm, ≥10 μm and ≤15 μm, ≥15 μm and ≤30 μm, ≥15 μm and ≤25 μm, ≥15 μm and ≤20 μm, ≥20 μm and ≤30 μm, ≥20 μm and ≤25 μm, or ≥25 μm and ≤30 μm. In embodiments, the diameter of the single core 121 may be greater than or equal to (i.e., ≥) 2 μm, ≥4 μm, ≥6 μm, ≥8 μm, ≥10 μm, ≥12 μm, ≥14 μm, ≥16 μm, ≥18 μm, ≥20 μm, ≥22 μm, ≥24 μm, ≥26 μm, ≥28 μm, or greater. In embodiments, the diameter of the single core 121 may be less than or equal to (i.e., ≤) 30 μm, ≤29 μm, ≤27 μm, ≤25 μm, ≤23 μm, ≤21 μm, ≤19 μm, ≤17 μm, ≤15 μm, ≤13 μm, ≤11 μm, ≤9 μm, ≤7 μm, ≤5 μm, ≤3 μm, or less.

In embodiments, a numerical aperture of the single core 121 may be greater than or equal to (i.e., ≥) 0.05 and less than or equal to (i.e., ≤) 0.5—including all sub-ranges or values therebetween. For example, in embodiments, the numerical aperture of the single core 121 may be ≥0.05 and ≤0.5, ≥0.05 and ≤0.45, ≥0.05 and ≤0.4, ≥0.05 and ≤0.35, ≥0.05 and ≤0.3, ≥0.05 and ≤0.25, ≥0.05 and ≤0.2, ≥0.05 and ≤0.15, ≥0.05 and ≤0.1, ≥0.1 and ≤0.5, ≥0.1 and ≤0.45, ≥0.1 and ≤0.4, ≥0.1 and ≤0.35, ≥0.1 and ≤0.3, ≥0.1 and ≤0.25, ≥0.1 and ≤0.2, ≥0.1 and ≤0.15, ≥0.15 and ≤0.5, ≥0.15 and ≤0.45, ≥0.15 and ≤0.4, ≥0.15 and ≤0.35, ≥0.15 and ≤0.3, ≥0.15 and ≤0.25, ≥0.15 and ≤0.2, ≥0.2 and ≤0.5, ≥0.2 and ≤0.45, ≥0.2 and ≤0.4, ≥0.2 and ≤0.35, ≥0.2 and ≤0.3, ≥0.2 and ≤0.25, ≥0.25 and ≤0.5, ≥0.25 and ≤0.45, ≥0.25 and ≤0.4, ≥0.25 and ≤0.35, ≥0.25 and ≤0.3, ≥0.3 and ≤0.5, ≥0.3 and ≤0.45, ≥0.3 and ≤0.4, ≥0.3 and ≤0.35, ≥0.35 and ≤0.5, ≥0.35 and ≤0.45, ≥0.35 and ≤0.4, ≥0.4 and ≤0.5, ≥0.4 and ≤0.45, ≥0.45 and ≤0.5. In embodiments, the numerical aperture of the single core 121 may be greater than or equal to (i.e., ≥) 0.05, ≥0.07, ≥0.09, ≥0.11, ≥0.13, ≥0.15, ≥0.17, ≥0.19, ≥0.21, ≥0.23, ≥0.25, ≥0.27, ≥0.29, ≥0.31, ≥0.33, ≥0.35, ≥0.37, ≥0.39, ≥0.41, ≥0.43, ≥0.45, ≥0.47, ≥0.49, or greater. In embodiments, the numerical aperture of the single core 121 may be less than or equal to (i.e., ≤) 0.5, ≤0.48, ≤0.46, ≤0.44, ≤0.42, ≤0.4, ≤0.38, ≤0.36, ≤0.34, ≤0.32, ≤0.3, ≤0.28, ≤0.26, ≤0.24, ≤0.22, ≤0.2, ≤0.18, ≤0.16, ≤0.14, ≤0.12, ≤0.1, ≤0.08, ≤0.06, or less.

The numerical aperture (NA) of an optical fiber can be measured using the method set forth in IEC-60793-1-43 (TIA SP3-2839-URV2 FOTP-177) entitled “Measurement Methods and Test Procedures—Numerical Aperture.

In embodiments, the core 121 of the single-core optical fiber 120 may have a mode field diameter (MFD) greater than or equal to (i.e., ≥) 2 μm and less than or equal to (i.e., ≤) 30 μm-including all sub-ranges or values therebetween. For example, in embodiments, the core 121 of the single-core optical fiber 120 may have a mode field diameter (MFD)≥2 μm and ≤30 μm, ≥2 μm and ≤25 μm, ≥2 μm and ≤20 μm, ≥2 μm and ≤15 μm, ≥2 μm and ≤10 μm, ≥2 μm and ≤5 μm, ≥5 μm and ≤30 μm, ≥5 μm and ≤25 μm, ≥5 μm and ≤20 μm, ≥5 μm and ≤15 μm, ≥5 μm and ≤10 μm, ≥10 μm and ≤30 μm, ≥10 μm and ≤25 μm, ≥10 μm and ≤20 μm, ≥10 μm and ≤15 μm, ≥15 μm and ≤30 μm, ≥15 μm and ≤25 μm, ≥15 μm and ≤20 μm, ≥20 μm and ≤30 μm, ≥20 μm and ≤25 μm, or ≥25 μm and ≤30 μm. In embodiments, the core 121 of the single-core optical fiber 120 may have a mode field diameter (MFD) greater than or equal to (i.e., ≥) 2 μm, ≥4 μm, ≥6 μm, ≥8 μm, ≥10 μm, ≥12 μm, ≥14 μm, ≥16 μm, ≥18 μm, ≥20 μm, ≥22 μm, ≥24 μm, ≥26 μm, ≥28 μm, or greater. In embodiments, the core 121 of the single-core optical fiber 120 may have a mode field diameter (MFD) less than or equal to (i.e., ≤) 30 μm, ≤28 μm, ≤26 μm, ≤24 μm, ≤22 μm, ≤20 μm, ≤18 μm, ≤16 μm, ≤14 μm, ≤12 μm, ≤10 μm, ≤8 μm, ≤6 μm, ≤4 μm, or less. Unless otherwise specified, the mode field diameter of the single-core optical fiber 120 refers to the mode field diameter at 980 nm. The mode field diameter can be measured using the Petermann II method.

### Multicore Optical Fiber

With reference to FIGS. 3A and 3D, the multicore optical fiber 140 may include a glass fiber 145 having a fiber axis or centerline CL and two or more cores or waveguides 141 disposed in a cladding 143 about the fiber axis CLM. The centerline of each core 141 may be parallel to the fiber axis CLM of the multicore optical fiber 140. Each of the cores 141 may be a single mode core or a multi-mode core depending on the particular multicore optical fiber 140. The cores 141 may be coupled cores or uncoupled cores. In embodiments, the cladding 143 may be a solid, uniform cladding. In embodiments, the cladding 143 may not include air or hollow channels. While in the exemplary embodiment shown in FIGS. 3A and 3D, the multicore optical fiber 140 includes four cores 141, the multicore optical fiber 140 may include less than four cores 141, more than four cores 141, as will be discussed in more detail below.

The cladding 143 of the multicore optical fiber 140 may have a cladding diameter DM. In embodiments, the cladding diameter Du of the multicore optical fiber 140 may be greater than or equal to (i.e., ≥) 60 μm and less than or equal to (i.e., ≤) 400 μm-including all sub-ranges or values therebetween. For example, in embodiments, the cladding diameter DMI of the multicore optical fiber 140 may be ≥60 μm and ≤400 μm, ≥60 μm and ≤350 μm, ≥60 μm and ≤300 μm, ≥60 μm and ≤250 μm, ≥60 μm and ≤200 μm, ≥60 μm and ≤150 μm, ≥60 μm and ≤100 μm, ≥100 μm and ≤400 μm, ≥100 μm and ≤350 μm, ≥100 μm and ≤300 μm, ≥100 μm and ≤250 μm, ≥100 μm and ≤200 μm, ≥100 μm and ≤150 μm, ≥150 μm and ≤400 μm, ≥150 μm and ≤350 μm, ≥150 μm and ≤300 μm, ≥150 μm and ≤250 μm, ≥150 μm and ≤200 μm, ≥200 μm and ≤400 μm, ≥200 μm and ≤350 μm, ≥200 μm and ≤300 μm, ≥200 μm and ≤250 μm, ≥250 μm and ≤400 μm, ≥250 μm and ≤350 μm, ≥250 μm and ≤300 μm, ≥300 μm and ≤400 μm, ≥300 μm and ≤350 μm, or ≥350 μm and ≤400 μm. In embodiments, the cladding diameter DM of the multicore optical fiber 140 may be greater than or equal to (i.e., ≥) 60 μm, ≥70 μm, ≥80 μm, ≥90 μm, ≥100 μm, ≥110 μm, ≥120 μm, ≥130 μm, ≥140 μm, ≥150 μm, ≥160 μm, ≥170 μm, ≥180 μm, ≥190 μm, ≥200 μm, ≥210 μm, ≥220 μm, ≥230 μm, ≥240 μm, ≥250 μm, ≥260 μm, ≥270 μm, ≥280 μm, ≥290 μm, ≥300 μm, ≥310 μm, ≥320 μm, ≥330 μm, ≥340 μm, ≥350 μm, ≥360 μm, ≥370 μm, ≥380 μm, ≥390 μm, or greater. In embodiments, the cladding diameter DM of the multicore optical fiber 140 may be less than or equal to (i.e., ≤) 400 μm, ≤390 μm, ≤380 μm, ≤370 μm, ≤360 μm, ≤350 μm, ≤340 μm, ≤330 μm, ≤320 μm, ≤310 μm, ≤300 μm, ≤290 μm, ≤280 μm, ≤270 μm, ≤260 μm, ≤250 μm, ≤240 μm, ≤230 μm, ≤220 μm, ≤210 μm, ≤200 μm, ≤190 μm, ≤180 μm, ≤170 μm, ≤160 μm, ≤150 μm, ≤140 μm, ≤130 μm, ≤120 μm, ≤110 μm, ≤100 μm, ≤90 μm, ≤80 μm, ≤70 μm, or less.

In embodiments, a diameter of each core 141 of the multicore optical fiber 140 may be greater than or equal to (i.e., ≥) 2 μm and less than or equal to (i.e., ≤) 30 μm-including all sub-ranges or values therebetween. For example, in embodiments, the diameter of each core 141 of the multicore optical fiber 140 may be ≥2 μm and ≤30 μm, ≥2 μm and ≤25 μm, ≥2 μm and ≤20 μm, ≥2 μm and ≤15 μm, ≥2 μm and ≤10 μm, ≥2 μm and ≤5 μm, ≥5 μm and ≤30 μm, ≥5 μm and ≤25 μm, ≥5 μm and ≤20 μm, ≥5 μm and ≤15 μm, ≥5 μm and ≤10 μm, ≥10 μm and ≤30 μm, ≥10 μm and ≤25 μm, ≥10 μm and ≤20 μm, ≥10 μm and ≤15 μm, ≥15 μm and ≤30 μm, ≥15 μm and ≤25 μm, ≥15 μm and ≤20 μm, ≥20 μm and ≤30 μm, ≥20 μm and ≤25 μm, or ≥25 μm and ≤30 μm. In embodiments, the diameter of each core 141 of the multicore optical fiber 140 may be greater than or equal to (i.e., ≥) 2 μm, ≥4 μm, ≥6 μm, ≥8 μm, ≥10 μm, ≥12 μm, ≥14 μm, ≥16 μm, ≥18 μm, ≥20 μm, ≥22 μm, ≥24 μm, ≥26 μm, ≥28 μm, or greater. In embodiments, the diameter of each core 141 of the multicore optical fiber 140 may be less than or equal to (i.e., ≤) 30 μm, ≤29 μm, ≤27 μm, ≤25 μm, ≤23 μm, ≤21 μm, ≤19 μm, ≤17 μm, ≤15 μm, ≤13 μm, ≤11 μm, ≤9 μm, ≤7 μm, ≤5 μm, ≤3 μm, or less.

In embodiments, a core pitch, as defined as the distance between the centers of nearest cores 141, may be greater than or equal to (i.e., ≥) 10 μm and less than or equal to (i.e., ≤) 60 μm-including all sub-ranges or values therebetween. In embodiments, the core pitch may be ≥10 μm and ≤60 μm, ≥10 μm and ≤50 μm, ≥10 μm and ≤40 μm, ≥10 μm and ≤30 μm, ≥10 μm and ≤20 μm, ≥20 μm and ≤60 μm, ≥20 μm and ≤50 μm, ≥20 μm and ≤40 μm, ≥20 μm and ≤30 μm, ≥30 μm and ≤60 μm, ≥30 μm and ≤50 μm, ≥30 and ≤40 μm, ≥40 μm and ≤60 μm, ≥40 μm and ≤50 μm, or ≥50 μm and ≤60 μm. In embodiments, the core pitch may be greater than or equal to (i.e., ≥) 10 μm, ≥15 μm, ≥20 μm, ≥25 μm, ≥30 μm, ≥35 μm, ≥40 μm, ≥45 μm, ≥50 μm, ≥55 μm, or greater. In embodiments, the core pitch may be less than or equal to (i.e., ≤) 60 μm, ≤55 μm, ≤50 μm, ≤45 μm, ≤40 μm, ≤35 μm, ≤30 μm, ≤25 μm, ≤20 μm, ≤15 μm, or less.

In embodiments, a numerical aperture of each core 141 may be greater than or equal to (i.e., ≥) 0.05 and less than or equal to (i.e., ≤) 0.5—including all sub-ranges or values therebetween. For example, in embodiments, the numerical aperture of each core 141 may be ≥0.05 and ≤0.5, ≥0.05 and ≤0.45, ≥0.05 and ≤0.4, ≥0.05 and ≤0.35, ≥0.05 and ≤0.3, ≥0.05 and ≤0.25, ≥0.05 and ≤0.2, ≥0.05 and ≤0.15, ≥0.05 and ≤0.1, ≥0.1 and ≤0.5, ≥0.1 and ≤0.45, ≥0.1 and ≤0.4, ≥0.1 and ≤0.35, ≥0.1 and ≤0.3, ≥0.1 and ≤0.25, ≥0.1 and ≤0.2, ≥0.1 and ≤0.15, ≥0.15 and ≤0.5, ≥0.15 and ≤0.45, ≥0.15 and ≤0.4, ≥0.15 and ≤0.35, ≥0.15 and ≤0.3, ≥0.15 and ≤0.25, ≥0.15 and ≤0.2, ≥0.2 and ≤0.5, ≥0.2 and ≤0.45, ≥0.2 and ≤0.4, ≥0.2 and ≤0.35, ≥0.2 and ≤0.3, ≥0.2 and ≤0.25, ≥0.25 and ≤0.5, ≥0.25 and ≤0.45, ≥0.25 and ≤0.4, ≥0.25 and ≤0.35, ≥0.25 and ≤0.3, ≥0.3 and ≤0.5, ≥0.3 and ≤0.45, ≥0.3 and ≤0.4, ≥0.3 and ≤0.35, ≥0.35 and ≤0.5, ≥0.35 and ≤0.45, ≥0.35 and ≤0.4, ≥0.4 and ≤0.5, ≥0.4 and ≤0.45, ≥0.45 and ≤0.5. In embodiments, the numerical aperture of each core 141 may be greater than or equal to (i.e., ≥) 0.05, ≥0.07, ≥0.09, ≥0.11, ≥0.13, ≥0.15, ≥0.17, ≥0.19, ≥0.21, ≥0.23, ≥0.25, ≥0.27, ≥0.29, ≥0.31, ≥0.33, ≥0.35, ≥0.37, ≥0.39, ≥0.41, ≥0.43, ≥0.45, ≥0.47, ≥0.49, or greater. In embodiments, the numerical aperture of each core 141 may be less than or equal to (i.e., ≤) 0.5, ≤0.48, ≤0.46, ≤0.44, ≤0.42, ≤0.4, ≤0.38, ≤0.36, ≤0.34, ≤0.32, ≤0.3, ≤0.28, ≤0.26, ≤0.24, ≤0.22, ≤0.2, ≤0.18, ≤0.16, ≤0.14, ≤0.12, ≤0.1, ≤0.08, ≤0.06, or less.

In embodiments, each of the cores 141 of the multicore optical fiber 140 may have a mode field diameter (MFD) greater than or equal to (i.e., ≥) 2 μm and less than or equal to (i.e., ≤) 30 μm-including all sub-ranges or values therebetween. For example, in embodiments, each of the cores 141 of the multicore optical fiber 140 may have a mode field diameter (MFD)≥2 μm and ≤30 μm, ≥2 μm and ≤25 μm, ≥2 μm and ≤20 μm, ≥2 μm and ≤15 μm, ≥2 μm and ≤10 μm, ≥2 μm and ≤5 μm, ≥5 μm and ≤30 μm, ≥5 μm and ≤25 μm, ≥5 μm and ≤20 μm, ≥5 μm and ≤15 μm, ≥5 μm and ≤10 μm, ≥10 μm and ≤30 μm, ≥10 μm and ≤25 μm, ≥10 μm and ≤20 μm, ≥10 μm and ≤15 μm, ≥15 μm and ≤30 μm, ≥15 μm and ≤25 μm, ≥15 μm and ≤20 μm, ≥20 μm and ≤30 μm, ≥20 μm and ≤25 μm, or ≥25 μm and ≤30 μm. In embodiments, each of the cores 141 of the multicore optical fiber 140 may have a mode field diameter (MFD) greater than or equal to (i.e., ≥) 2 μm, ≥4 μm, ≥6 μm, ≥8 μm, ≥10 μm, ≥12 μm, ≥14 μm, ≥16 μm, ≥18 μm, ≥20 μm, ≥22 μm, ≥24 μm, ≥26 μm, ≥28 μm, or greater. In embodiments, each of the cores 141 of the multicore optical fiber 140 may have a mode field diameter (MFD) less than or equal to (i.e., ≤) 30 μm, ≤28 μm, ≤26 μm, ≤24 μm, ≤22 μm, ≤20 μm, ≤18 μm, ≤16 μm, ≤14 μm, ≤12 μm, ≤10 μm, ≤8 μm, ≤6 μm, ≤4 μm, or less. Unless otherwise specified, the mode field diameter of the multicore optical fiber 140 refers to the mode field diameter at 980 nm.

In embodiments, the mode field diameter of the cores 141 of the multicore optical fiber 140 may be the same as the mode field diameter of the core 121 of the single-core optical fiber 120. In embodiments, a difference between the mode field diameter of the cores 141 of the multicore optical fiber 140 and the mode field diameter of the core 121 of the single-core optical fiber 120 may be less than or equal to (i.e., ≤) 50%, ≤40%, ≤30%, ≤20%, ≤10%, ≤5%, ≤3%, ≤1%, ≤0.5%, or less, when referenced to the larger one of the mode field diameter of the single-core optical fiber 120 and the mode field diameter of the multicore optical fiber 140.

### Beam-Splitting Optical Fiber

With reference to FIGS. 3A and 3C, the beam-splitting optical fiber 160 may include a glass fiber 165 having a fiber axis or centerline CL_{BS} and a single core or waveguide 161 disposed in a cladding 163 about the fiber axis CL_{BS}. In embodiments, the beam-splitting optical fiber 160 may include a multimode optical fiber. The centerline of the core 161 may be aligned with the fiber axis CL_{BS} of the beam-splitting optical fiber 160. The core 161 may include a polygonal cross section, and thus may also be referred to as the polygonal core 161. While in the exemplary embodiment shown in FIGS. 3A and 3C, the polygonal core 161 may include a square cross section, the cross section of the polygonal core 161 may include other polygonal shapes, as will be discussed in more detail below.

The cladding 163 of the beam-splitting optical fiber 160 may have a cladding diameter D_{BS}. In embodiments, the cladding diameter D_{BS} of the beam-splitting optical fiber 160 may be greater than or equal to (i.e., ≥) 60 μm and less than or equal to (i.e., ≤) 400 μm-including all sub-ranges or values therebetween. For example, in embodiments, the cladding diameter D_{BS} of the beam-splitting optical fiber 160 may be ≥60 μm and ≤400 μm, ≥60 μm and ≤350 μm, ≥60 μm and ≤300 μm, ≥60 μm and ≤250 μm, ≥60 μm and ≤200 μm, ≥60 μm and ≤150 μm, ≥60 μm and ≤100 μm, ≥100 μm and ≤400 μm, ≥100 μm and ≤350 μm, ≥100 μm and ≤300 μm, ≥100 μm and ≤250 μm, ≥100 μm and ≤200 μm, ≥100 μm and ≤150 μm, ≥150 μm and ≤400 μm, ≥150 μm and ≤350 μm, ≥150 μm and ≤300 μm, ≥150 μm and ≤250 μm, ≥150 μm and ≤200 μm, ≥200 μm and ≤400 μm, ≥200 μm and ≤350 μm, ≥200 μm and ≤300 μm, ≥200 μm and ≤250 μm, ≥250 μm and ≤400 μm, ≥250 μm and ≤350 μm, ≥250 μm and ≤300 μm, ≥300 μm and ≤400 μm, ≥300 μm and ≤350 μm, or ≥350 μm and ≤400 μm. In embodiments, the cladding diameter D_{BS} of the beam-splitting optical fiber 160 may be greater than or equal to (i.e., ≥) 60 μm, ≥70 μm, ≥80 μm, ≥90 μm, ≥100 μm, ≥110 μm, ≥120 μm, ≥130 μm, ≥140 μm, ≥150 μm, ≥160 μm, ≥170 μm, ≥180 μm, ≥190 μm, ≥200 μm, ≥210 μm, ≥220 μm, ≥230 μm, ≥240 μm, ≥250 μm, ≥260 μm, ≥270 μm, ≥280 μm, ≥290 μm, ≥300 μm, ≥310 μm, ≥320 μm, ≥330 μm, ≥340 μm, ≥350 μm, ≥360 μm, ≥370 μm, ≥380 μm, ≥390 μm, or greater. In embodiments, the cladding diameter D_{BS} of the beam-splitting optical fiber 160 may be less than or equal to (i.e., ≤) 400 μm, ≤390 μm, ≤380 μm, ≤370 μm, ≤360 μm, ≤350 μm, ≤340 μm, ≤330 μm, ≤320 μm, ≤310 μm, ≤300 μm, ≤290 μm, ≤280 μm, ≤270 μm, ≤260 μm, ≤250 μm, ≤240 μm, ≤230 μm, ≤220 μm, ≤210 μm, ≤200 μm, ≤190 μm, ≤180 μm, ≤170 μm, ≤160 μm, ≤150 μm, ≤140 μm, ≤130 μm, ≤120 μm, ≤110 μm, ≤100 μm, ≤90 μm, ≤80 μm, ≤70 μm, or less.

In embodiments, the polygonal core 161 may include an equilateral polygonal cross section in that the edges of the polygonal core 161 may include the same edge width w_{pc} (shown in FIG. 3C). In embodiments, the edge width w_{pc} may be greater than or equal to (i.e., ≥) 20 μm and less than or equal to (i.e., ≤) 250 μm-including all sub-ranges or values therebetween. For example, in embodiments, the edge width w_{pc} may be ≥20 μm and ≤250 μm, ≥20 μm and ≤200 μm, ≥20 μm and ≤150 μm, ≥20 μm and ≤100 μm, ≥20 μm and ≤50 μm, ≥50 μm and ≤250 μm, ≥50 μm and ≤200 μm, ≥50 μm and ≤150 μm, ≥50 μm and ≤100 μm, ≥100 μm and ≤250 μm, ≥100 μm and ≤200 μm, ≥100 μm and ≤150 μm, ≥150 μm and ≤250 μm, ≥150 μm and ≤200 μm, or ≥200 μm and ≤250 μm. In embodiments, the edge width w_{pc} may be greater than or equal to (i.e., ≥) 20 μm, ≥30 μm, ≥40 μm, ≥50 μm, ≥60 μm, ≥70 μm, ≥80 μm, ≥90 μm, ≥100 μm, ≥110 μm, ≥120 μm, ≥130 μm, ≥140 μm, ≥150 μm, ≥160 μm, ≥170 μm, ≥180 μm, ≥190 μm, ≥200 μm, ≥210 μm, ≥220 μm, ≥230 μm, ≥240 μm, or greater. In embodiments, the edge width w_{pc} may be less than or equal to (i.e., ≤) 250 μm, ≤240 μm, ≤230 μm, ≤220 μm, ≤210 μm, ≤200 μm, ≤190 μm, ≤180 μm, ≤170 μm, ≤160 μm, ≤150 μm, ≤140 μm, ≤130 μm, ≤120 μm, ≤110 μm, ≤90 μm, ≤80 μm, ≤70 μm, ≤60 μm, ≤50 μm, ≤40 μm, ≤30 μm, or less.

In embodiments, all corners of the polygonal cross section may all lie on a single circle having a radius r_{pc}, and thus may all be disposed at an equal radial distance r_{pc} (shown in FIG. 3C) from the fiber axis CL_{BS} of the beam-splitting optical fiber 160. In embodiments, the radial distance rpe may be greater than or equal to (i.e., ≥) 15 μm and less than or equal to (i.e., ≤) 150 μm-including all sub-ranges or values therebetween. For example, in embodiments, the radial distance Ipe may be ≥15 μm and ≤150 μm, ≥15 μm and ≤120 μm, ≥15 μm and ≤90 μm, ≥15 μm and ≤60 μm, ≥15 μm and ≤30 μm, ≥30 μm and ≤150 μm, ≥30 μm and ≤120 μm, ≥30 μm and ≤90 μm, ≥30 μm and ≤60 μm, ≥60 μm and ≤150 μm, ≥60 μm and ≤120 μm, ≥60 μm and ≤90 μm, ≥90 μm and ≤150 μm, ≥90 μm and ≤120 μm, or ≥120 μm and ≤150 μm. In embodiments, the radial distance r_{pc} may be greater than or equal to (i.e., ≥) 15 μm, ≥25 μm, ≥35 μm, ≥45 μm, ≥55 μm, ≥65 μm, ≥75 μm, ≥85 μm, ≥95 μm, ≥105 μm, ≥115 μm, ≥125 μm, ≥135 μm, ≥145 μm, or greater. In embodiments, the radial distance Ipe may be less than or equal to (i.e., ≤) 150 μm, ≤140 μm, ≤130 μm, ≤120 μm, ≤110 μm, ≤100 μm, ≤90 μm, ≤80 μm, ≤70 μm, ≤60 μm, ≤50 μm, ≤40 μm, ≤30 μm, ≤20 μm, or less.

In embodiments, a numerical aperture of the polygonal core 161 may be greater than or equal to (i.e., ≥) 0.05 and less than or equal to (i.e., ≤) 0.5—including all sub-ranges or values therebetween. For example, in embodiments, the numerical aperture of the polygonal core 161 may be ≥0.05 and ≤0.5, ≥0.05 and ≤0.4, ≥0.05 and ≤0.3, ≥0.05 and ≤0.2, ≥0.05 and ≤0.1, ≥0.1 and ≤0.5, ≥0.1 and ≤0.4, ≥0.1 and ≤0.3, ≥0.1 and ≤0.2, ≥0.2 and ≤0.5, ≥0.2 and ≤0.4, ≥0.2 and ≤0.3, ≥0.3 and ≤0.5, ≥0.3 and ≤0.4, or ≥0.4 and ≤0.5. In embodiments, the numerical aperture of the polygonal core 161 may be greater than or equal to (i.e., ≥) 0.05, ≥0.1, ≥0.15, ≥0.2, ≥0.25, ≥0.3, ≥0.35, ≥0.4, ≥0.45, or greater. In embodiments, the numerical aperture of the polygonal core 161 may be less than or equal to (i.e., ≤) 0.5, ≤0.45, ≤0.4, ≤0.35, ≤0.3, ≤0.25, ≤0.2, ≤0.15, ≤0.1, or less. In embodiments, the refractive index of the polygonal core 161 may be constant within the polygonal core 161.

In embodiments, a fiber length LBs of the beam-splitting optical fiber 160 may be greater than or equal to (i.e., ≥) 0.1 mm and less than or equal to (i.e., ≤) 100 mm-including all sub-ranges or values therebetween. For example, in embodiments, the fiber length LBs of the beam-splitting optical fiber 160 may be ≥0.1 mm and ≤100 mm, ≥0.1 mm and ≤80 mm, ≥0.1 mm and ≤60 mm, ≥0.1 mm and ≤40 mm, ≥0.1 mm and ≤20 mm, ≥10 mm and ≤100 mm, ≥10 mm and ≤80 mm, ≥10 mm and ≤60 mm, ≥10 mm and ≤40 mm, ≥10 mm and ≤20 mm, ≥30 mm and ≤100 mm, ≥30 mm and ≤80 mm, ≥30 mm and ≤60 mm, ≥30 mm and ≤40 mm, ≥50 mm and ≤100 mm, ≥50 mm and ≤80 mm, ≥50 mm and ≤60 mm, ≥70 mm and ≤100 mm, ≥70 mm and ≤80 mm, ≥90 mm and ≤100 mm. In embodiments, the fiber length LBs of the beam-splitting optical fiber 160 may be greater than or equal to (i.e., ≥) 0.1 mm, ≥1 mm, ≥5 mm, ≥10 mm, ≥15 mm, ≥20 mm, ≥25 mm, ≥30 mm, ≥35 mm, ≥40 mm, ≥45 mm, ≥50 mm, ≥55 mm, ≥60 mm, ≥65 mm, ≥70 mm, ≥75 mm, ≥80 mm, ≥85 mm, ≥90 mm, ≥95 mm, or greater. In embodiments, the fiber length LBs of the beam-splitting optical fiber 160 may be less than or equal to (i.e., ≤) 100 mm, ≤95 mm, ≤90 mm, ≤85 mm, ≤80 mm, ≤75 mm, ≤70 mm, ≤65 mm, ≤60 mm, ≤55 mm, ≤50 mm, ≤45 mm, ≤40 mm, ≤35 mm, ≤30 mm, ≤25 mm, ≤20 mm, ≤15 mm, ≤10 mm, ≤5 mm, ≤1 mm, or less. The fiber length LBs of the beam-splitting optical fiber 160 may be at least in part determined by the output beam spot pattern and/or the arrangement of the cores 141 of the multicore optical fiber 140 (discussed below).

### Beam Propagation Simulation

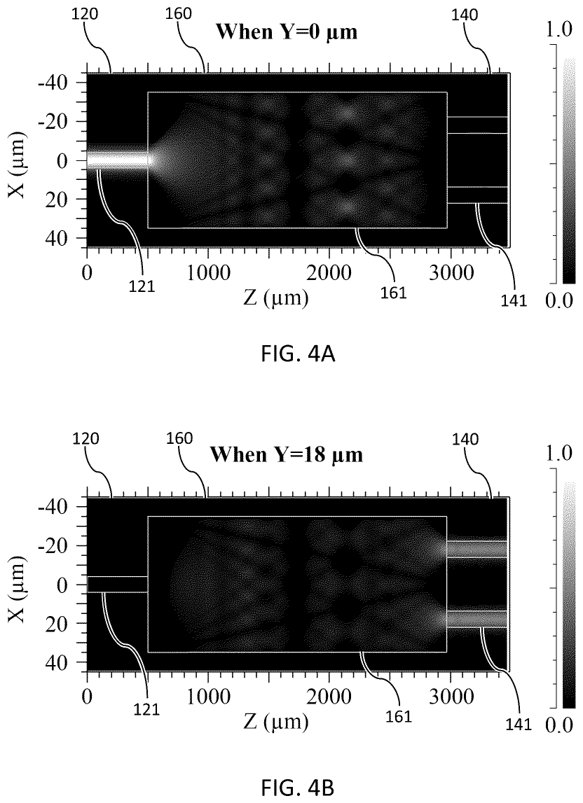

FIGS. 4A and 4B show simulations of light propagation from the input single-core optical fiber 120 to the output multicore optical fiber 140 via the beam-splitting optical fiber 160 and the multimode interference (MMI) evolution inside the beam-splitting optical fiber 160. The simulation is based on the beam propagation method as described in R. Scarmozzino, A. Gopinath, R. Pregla and S. Helfert, “Numerical techniques for modeling guided-wave photonic devices,” in IEEE Journal of Selected Topics in Quantum Electronics, vol. 6, no. 1, pp. 150-162, January-February 2000, doi: 10.1109/2944.826883, the content of which is incorporated herein by reference in its entirety.

For the simulation, the following parameters are assumed: the single-core optical fiber 120 is a G.652 fiber having a core diameter of 8.2 μm, a mode field diameter of 10.4 μm, and a numerical aperture of 0.12; the multicore optical fiber 140 is a four-core multicore optical fiber 140 having the same core design as the single-core optical fiber 120 (i.e., a core diameter of 8.2 μm, a mode field diameter of 10.4 μm, and a numerical aperture of 0.12) and a core pitch of 36 μm; and the beam-splitting optical fiber 160 is a commercially available square-core optical fiber 160 from CeramOptec having a core edge width w_{pc} of 70 μm and a numerical aperture of 0.22, and the fiber length LBs of the beam-splitting optical fiber 160 is 2470 μm. The power splitter 100 is assumed to be operating at 1550 nm for simulation and illustration purposes. It should be noted that the power splitter 100 described herein can be adapted for a wide range of operating wavelength, such as 400 nm to 2000 nm, based on principles described in, e.g., L. B. Soldano and E. C. M. Pennings, “Optical multi-mode interference devices based on self-imaging: principles and applications,” Journal of Lightwave Technology, vol. 13, no. 4, pp. 615-627, April 1995, doi: 10.1109/50.372474, the content of which is incorporated herein by reference in its entirety.

FIG. 4A shows the simulated intensity profile taken at or along the centerlines of the single-core optical fiber 120, the beam-splitting optical fiber 160, and the multicore optical fiber 140 (i.e., Y=0 μm location). FIG. 4B shows the simulated intensity profile taken at a location offset from the centerlines of the single-core optical fiber 120, the beam-splitting optical fiber 160, and the multicore optical fiber 140, more specifically, along the centerlines of two of the four cores of the multicore optical fiber 140 (i.e., Y=18 μm location). As no core 141 is located at the centerline of the multicore optical fiber 140, no light propagation is shown in the two cores 141 of the multicore optical fiber 140 shown in FIG. 4A. Similarly, as the single core 121 of the single-core optical fiber 120 is located at the centerline of the single-core optical fiber 120, no light propagation is shown in the single core 121 in FIG. 4B, rather the light propagation in the two cores 141 of the multicore optical fiber 140 is shown.

n×n Beam Lattice Pattern

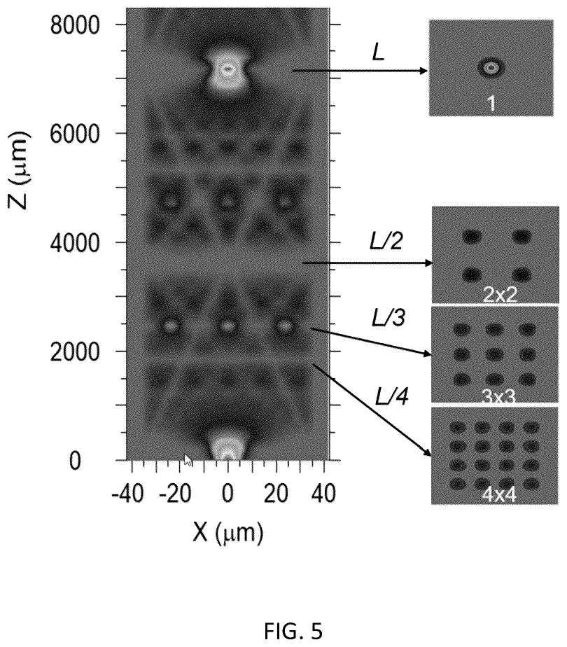

For light from the single-core optical fiber 120 to split into the four cores 141 of the multicore optical fiber 140, the square-core, beam-splitting optical fiber 160 is a multimode fiber and supports multiple spatial modes, resulting in various multimode interference patterns at different locations along the fiber length LBs of the beam-splitting optical fiber 160. FIG. 5 shows various multibeam patterns generated at different locations along the fiber length LBs of the beam-splitting optical fiber 160.

Using the self-image length L of beam-splitting optical fiber 160, at which location the original beam profile can be completely restored, n×n replicas (same mode field diameter but 1/n² power) of the input beam can be generated at L/n length due to multimode interference. For example, 2×2 replicas (same mode field diameter, ¼ power) of the input beam can be generated at L/2 length, 3×3 replicas (same mode field diameter, 1/9 power) of the input beam can be generated at L/3 length, 4×4 replicas (same mode field diameter, 1/16 power) of the input beam can be generated at L/4 length, etc. For output to the four-core, multicore optical fiber 140, the fiber length LBs of the beam-splitting optical fiber 160 may thus be selected to correspond to L/2 length to output a 2×2 multimode interference beam pattern while minimizing loss.

At each L/n location, the distance between the centers of neighboring beam spots of the generated n×n multimode interference beam pattern may be approximately 1/n of the edge width w_{pc} of the square core 161 (exact distance may be slightly greater than 1/n of the edge width w_{pc} of the square core 161 due to the Goos-Hanchen effect where light penetrates slightly into the cladding, such as described in L. B. Soldano and E. C. M. Pennings, “Optical multi-mode interference devices based on self-imaging: principles and applications,” which is referenced above and incorporated herein by reference). For example, the distance between the centers of neighboring beam spots in the 2×2 multimode interference beam pattern at L/2 length may be approximately ½ edge width w_{pc} of the core 161, the distance between the centers of neighboring beam spots in the 3×3 multimode interference beam pattern at L/3 length may be approximately ⅓ edge width w_{pc} of the core 161, the distance between the centers of neighboring beam spots in the 4×4 multimode interference beam pattern at L/4 length may be approximately ¼ edge width w_{pc} of the core 161, etc. For output to the four-core, multicore optical fiber 140, the beam-splitting optical fiber 160 may thus be configured with a square core 161 having an edge width w_{pc} that may correspond to 2× the core pitch of the multicore optical fiber 140 to minimize loss.

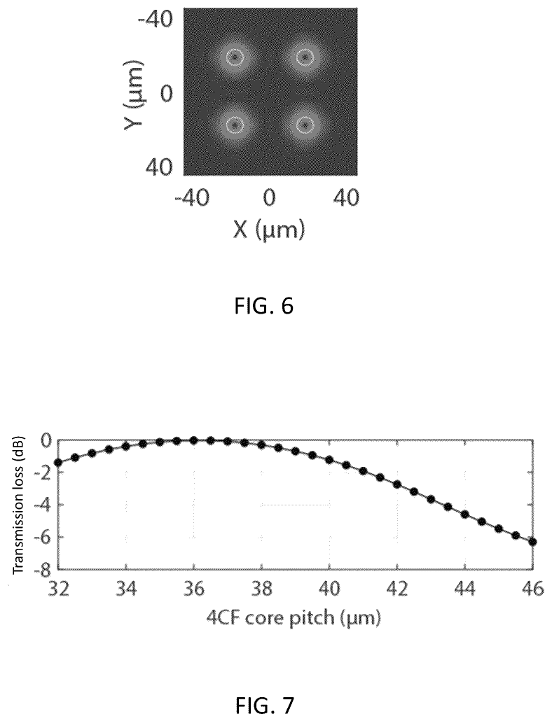

In the exemplary power splitter 100 simulated, the fiber length LBs of the beam-splitting optical fiber 160 is 2470 μm, and the edge width w_{pc} of the square core 161 of the beam-splitting optical fiber 160 is 70 μm, for outputting the 2×2 multimode interference pattern at the operating wavelength of 1550 nm. FIG. 6 shows the resulting transverse field profile (calculated) at the output end of the square-core, beam-splitting optical fiber 160. For other operating wavelengths and/or different core pitches of the multicore optical fiber 140, appropriate fiber length LBs of the beam-splitting optical fiber 160 and/or the edge width w_{pc} of the square core 161 may be selected.

Although a square-core, beam-splitting optical fiber 160 are used as an example for illustrative purposes, the polygonal core 161 of the beam-splitting optical fiber 160 may include any polygonal shapes, such as equilateral polygons, including but not limited to triangle, square, pentagon, hexagon, heptagon, octagon, nonagon, decagon, etc., for generating different multimode interference beam patterns to accommodate various core arrangement of the multicore optical fiber 140.

### Low Insertion Loss

The performance of the power splitter 100 described herein may be characterized by its insertion loss, which is defined as follows:

$$Insertion Loss ( dB ) = - 10 \times {log}_{10} \frac{{P}_{output}}{{P}_{i nput}}$$

where Pₒᵤₜₚᵤₜ is the combined output power from all cores 141 of the multicore optical fiber 140, and Pᵢₙₚᵤₜ is the power input into the single-core optical fiber 120.

FIG. 7 shows simulated transmission loss (transition loss=−insertion loss, and insertion loss=|transmission loss|) of the power splitter 100 as a function of core pitch. For the simulation shown in FIG. 7, the same parameters as those used in simulation shown in FIGS. 4A and 4B are assumed, except for the varying core pitch of the multicore optical fiber 140. As shown, the insertion loss of the power splitter 100 described herein can be as low as 0.03 dB when the distance between neighboring beam spots of the generated multimode interference beam pattern substantially corresponds to the core pitch of the multicore optical fiber 140. However, it should be noted that, even when the distance between neighboring beam spots of the output multimode interference beam pattern and the core pitch of the multicore optical fiber 140 may not correspond to each other, the power splitter 100 described herein may still achieve low insertion loss (≤1 dB). In embodiments, the difference between the distance between neighboring beam spots of the output multimode interference beam pattern and the core pitch of the multicore optical fiber 140, when referenced to the larger one of the neighboring spot distance and the core pitch, may be greater than or equal to (i.e., ≥) 0% and less than or equal to (i.e., ≤) 10% (including all sub-ranges or values therebetween, e.g., ≥0% and ≤8%, ≥0% and ≤6%, ≥0% and ≤4%, or ≥0% and ≤2%) while a low insertion loss (≤1 dB) may still be consistently achieved.

To further reduce insertion loss, the input single-core optical fiber 120 and the output multicore optical fiber 140 of the power splitter 100 described herein may be further configured with matching or similar mode field diameter to achieve fundamental mode match between the input single-core optical fiber 120 and the output multicore optical fiber 140. Nonetheless, the power splitter 100 described herein may still achieve low insertion loss (e.g., ≤1 dB) while allowing some mismatch (e.g., up to 50% difference as discussed above) between the mode field diameters of the single-core optical fiber 120 and the multicore optical fiber 140 the power splitter 100.

### Graded-Index-Fiber-Assisted Power Splitter

As discussed above, the power splitter 100 described herein may allow for a certain extent of mismatch between the mode field diameter of the core 121 of the single-core optical fiber 120 and the mode field diameter of the cores 141 of the multicore optical fiber 140 while still achieving low insertion low. However, to effectively manage larger mismatch which may cause more coupling loss or to expand the applicability of the power splitter 100 to a wide varieties of single-core optical fibers 120 and multicore optical fibers 140, in embodiments, a graded-index fiber and/or a coreless fiber may be integrated into the power splitter 100 to effectively manage any mismatch. Specifically, the graded-index fiber may function as a lens element, and the coreless fiber may function as a spacer. With appropriate index and/or length of the graded-index fiber and/or the coreless fiber, the distance between the neighboring beam spots of the multimode interference beam pattern at the output end of the beam-splitting optical fiber 160 may be further adjusted. Depending on the arrangement of the graded-index fiber and the coreless fiber, the distance between the neighboring beam spots at the output end of the beam-splitting optical fiber 160 may be either magnified or demagnified to cater for or match different core pitch of the multicore optical fiber 140. It should be noted that with such magnification or demagnification of the distance between the neighboring beam spots, the mode field diameter of the beam spots of the multimode interference beam pattern may also be magnified or demagnified. However, the magnification or demagnification of the mode field diameters may not significantly impact the insertion loss, and any increase in insertion loss due to magnification or demagnification of the mode field diameters would be outweighed by the significant loss reduction obtained by matching the distance between the neighboring beam spots of the multimode interference beam pattern to the core pitch of the multicore optical fiber 140.

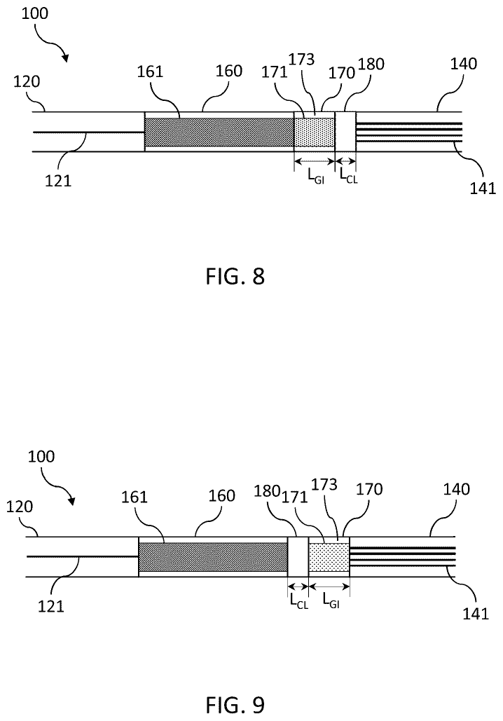

FIG. 8 schematically illustrates an exemplary power splitter 100 incorporating a graded-index optical fiber 170 and a coreless optical fiber 180 for magnifying the distance between neighboring beam spots at the output end of the beam-splitting optical fiber 160 to match larger core pitches of various multicore optical fibers 140. In embodiments, the input end of the graded-index optical fiber 170 may be coupled to the output end of the beam-splitting optical fiber 160. The output end of the graded-index optical fiber 170 may be coupled to the input end of the coreless optical fiber 180. The output end of the coreless optical fiber 180 may be further coupled to the input end of the multicore optical fiber 140.

FIG. 9 schematically illustrates another exemplary power splitter 100 incorporating a graded-index optical fiber 170 and a coreless optical fiber 180 for demagnifying the distance between neighboring beam spots at the output end of the beam-splitting optical fiber 160 to match smaller core pitches of various multicore optical fibers 140. In embodiments, the input end of the coreless optical fiber 180 may be coupled to the output end of the beam-splitting optical fiber 160. The output end of the coreless optical fiber 180 may be coupled to the input end of the graded-index optical fiber 170. The output end of the graded-index optical fiber 170 may be further coupled to the input end of the multicore optical fiber 140.

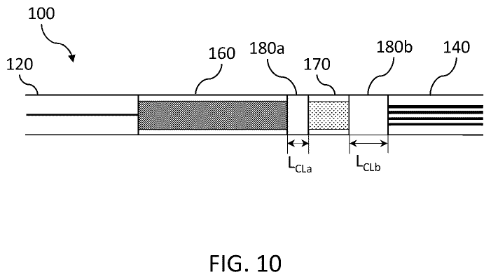

FIG. 10 schematically illustrates another exemplary power splitter 100 incorporating a graded-index optical fiber 170, a first coreless optical fibers 180a, and a second coreless optical fiber 180b, with the graded-index optical fiber 170 disposed or sandwiched between the first coreless optical fibers 180a and the second coreless optical fibers 180b. The input end of the first coreless optical fibers 180a may be coupled to the output end of the beam-splitting optical fiber 160, and the output end of the first coreless optical fibers 180a may be coupled to the input end of the graded-index optical fiber 170. The input end of the second coreless optical fibers 180b may be coupled to the output end of the graded-index optical fiber 170, and the output end of the second coreless optical fibers 180b may be coupled to the input end of the multicore optical fiber 140. The first coreless optical fibers 180a may include a first length L_{CLa}. The second coreless optical fibers 180b may include a second length L_{CLb}.

In embodiments, by adjusting the first length L_{CLa} and/or the second length L_{CLb}, the distance between neighboring beam spots of the multimode interference beam pattern output from the beam-splitting optical fiber 160 may be magnified or demagnified to accommodate various core pitch values of the multicore optical fiber 140. For example, in embodiments, the first length L_{CLa} may be greater than the second length L_{CLb} such that the distance between neighboring beam spots of the multimode interference beam pattern may be demagnified. In embodiments, the first length L_{CLa} may be less than the second length L_{CLb} such that the distance between neighboring beam spots of the multimode interference beam pattern may be magnified.

With appropriate index profile of the graded-index optical fiber 170, the length LGI of the graded-index optical fiber 170, and/or the length(s) LCL of the coreless optical fiber(s) 180, the distance between neighboring beam spots at the output end of the beam-splitting optical fiber 160 may be either magnified or demagnified using an appropriate power splitter 100 such as those shown in FIGS. 8, 9, and 10. By incorporating a graded-index optical fiber 170 as the lens element and/or a coreless optical fiber 180 as the spacer, the power splitter 100 described herein may allow for the same beam-splitting optical fiber 160 and/or same input single-core optical fiber 120 to be used with different multicore optical fibers 140 having various core pitches.

### Graded-Index Optical Fiber

In embodiments, the graded-index optical fiber 170 may include a core 171 having a core radius r₁ and a cladding 173 surrounding the core 171 and having a cladding radius 12. In embodiments, the graded-index optical fiber 170 may be a multimode fiber.

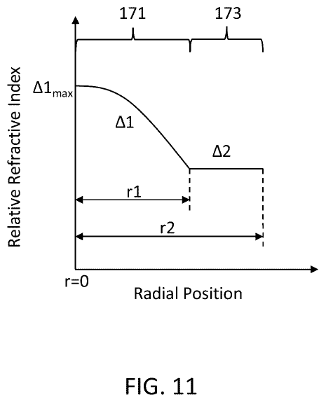

FIG. 11 plots a relative refractive index profile of an exemplary graded-index optical fiber 170. The “relative refractive index” of the graded-index optical fiber 170 is defined according to the following equation:

$$Δ \% = 100 \frac{{n}^{2} ( r ) - {n}_{c}^{2}}{2 {n}^{2} ( r )}$$

where n(r) is the refractive index at the radial distance r from the centerline of the graded-index optical fiber 170 at a wavelength of 1550 nm unless otherwise specified, and n_{c} is 1.444, which is the refractive index of undoped silica glass at a wavelength of 1550 nm.

In embodiments, the core 171 of the graded-index optical fiber 170 may include a relative refractive index Δ1 having a parabolic shape and gradually decreasing from the center of the graded-index optical fiber 170. In embodiments, a maximum relative refractive index Δ1ₘₐₓ of the graded-index optical fiber 170 may be greater than or equal to (i.e., ≥) 0.35 Δ% and less than or equal to (i.e., ≤) 3 Δ%-including all sub-ranges or values therebetween. For example, in embodiments, the maximum relative refractive index Δ1ₘₐₓ of the graded-index optical fiber 170 may be ≥0.35 Δ% and ≤3 Δ%, ≥0.35 Δ% and ≤2.5 Δ%, ≥0.35 Δ% and ≤2 Δ%, ≥0.35 Δ% and ≤1.5 Δ%, ≥0.35 Δ% and ≤1 Δ%, ≥0.35 Δ% and ≤0.5 Δ%, ≥0.5 Δ% and ≤3 Δ%, ≥0.5 Δ% and ≤2.5 Δ%, ≥0.5 Δ% and ≤2 Δ%, ≥0.5 Δ% and ≤1.5 Δ%, ≥0.5 Δ% and ≤1 Δ%, ≥1 Δ% and ≤3 Δ%, ≥1 Δ% and ≤2.5 Δ%, ≥1 Δ% and ≤2 Δ%, ≥1 Δ% and ≤1.5 Δ%, ≥1.5 Δ% and ≤3 Δ%, ≥1.5 Δ% and ≤2.5 Δ%, ≥1.5 Δ% and ≤2 Δ%, ≥2 Δ% and ≤3 Δ%, ≥2 Δ% and ≤2.5 Δ%, or ≥2.5 Δ% and ≤3 Δ%. In embodiments, the maximum relative refractive index Δ1ₘₐₓ of the graded-index optical fiber 170 may be greater than or equal to (i.e., 2) 0.35 Δ%, ≥0.5 Δ%, ≥0.7 Δ%, ≥0.9 Δ%, ≥1.1 Δ%, ≥1.3 Δ%, ≥1.5 Δ%, ≥1.7 Δ%, 2 1.9 Δ%, ≥2.1 Δ%, ≥2.3 Δ%, ≥2.5 Δ%, ≥2.7 Δ%, ≥2.9 Δ%, or greater. In embodiments, the maximum relative refractive index Δ1ₘₐₓ of the graded-index optical fiber 170 may be less than or equal to (i.e., ≤) 3 Δ%, ≤2.8 Δ%, ≤2.6 Δ%, ≤2.4 Δ%, ≤2.2 Δ%, ≤2 Δ%, ≤1.8 Δ%, ≤1.6 Δ%, ≤1.4 Δ%, ≤1.2 Δ%, ≤1 Δ%, ≤0.8 Δ%, ≤0.6 Δ%, ≤0.4 Δ%, or less. In embodiments, the maximum relative refractive index Δ1ₘₐₓ may be present at the r=0 location.

In embodiments, the core radius r₁ of the graded-index optical fiber 170 may be greater than or equal to (i.e., ≥) 10 μm and less than or equal to (i.e., ≤) 150 μm-including all sub-ranges or values therebetween. For example, in embodiments, the core radius r₁ of the graded-index optical fiber 170 may be ≥10 μm and ≤150 μm, ≥10 μm and ≤120 μm, ≥10 μm and ≤90 μm, ≥10 μm and ≤60 μm, ≥10 μm and ≤30 μm, ≥30 μm and ≤150 μm, ≥30 μm and ≤120 μm, ≥30 μm and ≤90 μm, ≥30 μm and ≤60 μm, ≥60 μm and ≤150 μm, ≥60 μm and ≤120 μm, ≥60 μm and ≤90 μm, ≥90 μm and ≤150 μm, ≥90 μm and ≤120 μm, or ≥120 μm and ≤150 μm. In embodiments, the core radius r₁ of the graded-index optical fiber 170 may be greater than or equal to (i.e., ≥) 10 μm, ≥20 μm, ≥30 μm, ≥40 μm, ≥50 μm, ≥60 μm, ≥70 μm, ≥80 μm, ≥90 μm, ≥100 μm, ≥110 μm, ≥120 μm, ≥130 μm, ≥140 μm, or greater. In embodiments, the core radius r₁ of the graded-index optical fiber 170 may be less than or equal to (i.e., ≤) 150 μm, ≤140 μm, ≤130 μm, ≤120 μm, ≤110 μm, ≤100 μm, ≤90 μm, ≤80 μm, ≤70 μm, ≤60 μm, ≤50 μm, ≤40 μm, ≤30 μm, ≤20 μm, or less.

The core radius r₁ of the graded-index optical fiber 170 may be sufficiently large such that the output from the beam-splitting optical fiber 160 may be collected to reduced loss. For example, in embodiments, the core radius r₁ of the graded-index optical fiber 170 may be greater than or equal to the radial distance r_{pc} (see, e.g., FIG. 3C) at which the corners of the polygonal core 161 of the beam-splitting optical fiber 160 may be disposed. In embodiments, the core diameter (2×r₁) of the graded-index optical fiber 170 may be greater than or equal to the edge width w_{pc} (see, e.g., FIG. 3C) of the polygonal core 161 of the beam-splitting optical fiber 160.

In embodiments, the cladding 173 of the graded-index optical fiber 170 may include a relative refractive index 42 that may be constant or substantially constant. In embodiments, the relative refractive index 42 may be greater than or equal to (i.e., ≥) −0.05 Δ% and less than or equal to (i.e., ≤) 0.05 Δ% or about 0 Δ%. In embodiments, the cladding radius r₂ may be greater than or equal to (i.e., ≥) 50 μm and less than or equal to (i.e., ≤) 200 μm-including all sub-ranges or values therebetween. For example, in embodiments, the cladding radius r₂ may be ≥50 μm and ≤200 μm, ≥50 μm and ≤170 μm, ≥50 μm and ≤140 μm, ≥50 μm and ≤110 μm, ≥50 μm and ≤80 μm, ≥80 μm and ≤200 μm, ≥80 μm and ≤170 μm, ≥80 μm and ≤140 μm, ≥80 μm and ≤110 μm, ≥110 μm and ≤200 μm, ≥110 μm and ≤170 μm, ≥110 μm and ≤140 μm, ≥140 μm and ≤200 μm, ≥140 μm and ≤170 μm, or ≥170 μm and ≤200 μm. In embodiments, the cladding radius r₂ may be greater than or equal to (i.e., ≥) 50 μm, ≥60 μm, ≥70 μm, ≥80 μm, ≥90 μm, ≥100 μm, ≥110 μm, ≥120 μm, ≥130 μm, ≥140 μm, ≥150 μm, ≥160 μm, ≥170 μm, ≥180 μm, ≥190 μm, or greater. In embodiments, the cladding radius 12 may be less than or equal to (i.e., ≤) 200 μm, ≤190 μm, ≤180 μm, ≤170 μm, ≤160 μm, ≤150 μm, ≤140 μm, ≤130 μm, ≤120 μm, ≤110 μm, ≤100 μm, ≤90 μm, ≤80 μm, ≤70 μm, ≤60 μm, or less.

In embodiments, the length LGI of the graded-index optical fiber 170 may be greater than or equal to (i.e., ≥) 100 μm and less than or equal to (i.e., ≤) 2000 μm-including all sub-ranges or values therebetween. For example, in embodiments, the length LGI of the graded-index optical fiber 170 may be ≥100 μm and ≤2000 μm, ≥100 μm and ≤1700 μm, ≥100 μm and ≤1400 μm, ≥100 μm and ≤1100 μm, ≥100 μm and ≤800 μm, ≥100 μm and ≤500 μm, ≥100 μm and ≤200 μm, ≥200 μm and ≤2000 μm, ≥200 μm and ≤1700 μm, ≥200 μm and ≤1400 μm, ≥200 μm and ≤1100 μm, ≥200 μm and ≤800 μm, ≥200 μm and ≤500 μm, ≥500 μm and ≤2000 μm, ≥500 μm and ≤1700 μm, ≥500 μm and ≤1400 μm, ≥500 μm and ≤1100 μm, ≥500 μm and ≤800 μm, ≥800 μm and ≤2000 μm, ≥800 μm and ≤1700 μm, ≥800 μm and ≤1400 μm, ≥800 μm and ≤1100 μm, ≥1100 μm and ≤2000 μm, ≥1100 μm and ≤1700 μm, ≥1100 μm and ≤1400 μm, ≥1400 μm and ≤2000 μm, ≥1400 μm and ≤1700 μm, or ≥1700 μm and ≤2000 μm. In embodiments, the length LGI of the graded-index optical fiber 170 may be greater than or equal to (i.e., ≥) 100 μm, ≥200 μm, ≥300 μm, ≥400 μm, ≥500 μm, ≥600 μm, ≥700 μm, ≥800 μm, ≥900 μm, ≥1000 μm, ≥1100 μm, ≥1200 μm, ≥1300 μm, ≥1400 μm, ≥1500 μm, ≥1600 μm, ≥1700 μm, ≥1800 μm, ≥1900 μm, or greater. In embodiments, the length LGI of the graded-index optical fiber 170 may be less than or equal to (i.e., ≤) 2000 μm, ≤1900 μm, ≤1800 μm, ≤1700 μm, ≤1600 μm, ≤1500 μm, ≤1400 μm, ≤1300 μm, ≤1200 μm, ≤1100 μm, ≤1000 μm, ≤900 μm, ≤800 μm, ≤700 μm, ≤600 μm, ≤500 μm, ≤400 μm, ≤300 μm, ≤200 μm, or less.

### Coreless Optical Fiber

In embodiments, the length LcI, of the coreless optical fiber 180 may be greater than or equal to (i.e., ≥) 50 μm and less than or equal to (i.e., ≤) 3000 μm-including all sub-ranges or values therebetween. For example, in embodiments, the length LcI, of the coreless optical fiber 180 may be ≥50 μm and ≤3000 μm, ≥50 μm and ≤2500 μm, ≥50 μm and ≤2000 μm, ≥50 μm and ≤1500 μm, ≥50 μm and ≤1000 μm, ≥50 μm and ≤500 μm, ≥500 μm and ≤3000 μm, ≥500 μm and ≤2500 μm, ≥500 μm and ≤2000 μm, ≥500 μm and ≤1500 μm, ≥500 μm and ≤1000 μm, ≥1000 μm and ≤3000 μm, ≥1000 μm and ≤2500 μm, ≥1000 μm and ≤2000 μm, ≥1000 μm and ≤1500 μm, ≥1500 μm and ≤3000 μm, ≥1500 μm and ≤2500 μm, ≥1500 μm and ≤2000 μm, ≥2000 μm and ≤3000 μm, ≥2000 μm and ≤2500 μm, or ≥2500 μm and ≤3000 μm. In embodiments, the length LcI, of the coreless optical fiber 180 may be greater than or equal to (i.e., ≥) 50 μm, ≥100 μm, ≥200 μm, ≥300 μm, ≥400 μm, ≥500 μm, ≥600 μm, ≥700 μm, ≥800 μm, ≥900 μm, ≥1000 μm, ≥1100 μm, ≥1200 μm, ≥1300 μm, ≥1400 μm, ≥1500 μm, ≥1600 μm, ≥1700 μm, ≥1800 μm, ≥1900 μm, ≥2000 μm, ≥2100 μm, ≥2200 μm, ≥2300 μm, ≥2400 μm, ≥2500 μm, ≥2600 μm, ≥2700 μm, ≥2800 μm, ≥2900 μm, or greater. In embodiments, the length LcI, of the coreless optical fiber 180 may be less than or equal to (i.e., ≤) 3000 μm, ≤2900 μm, ≤2800 μm, ≤2700 μm, ≤2600 μm, ≤2500 μm, ≤2400 μm, ≤2300 μm, ≤2200 μm, ≤2100 μm, ≤2000 μm, ≤1900 μm, ≤1800 μm, ≤1700 μm, ≤1600 μm, ≤1500 μm, ≤1400 μm, ≤1300 μm, ≤1200 μm, ≤1100 μm, ≤1000 μm, ≤900 μm, ≤800 μm, ≤700 μm, ≤600 μm, ≤500 μm, ≤400 μm, ≤300 μm, ≤200 μm, ≤100μ, or less. The coreless optical fiber 180 may include an optical fiber made of undoped or doped silica.

While the single-core optical fiber 120, the multicore optical fiber 140, the beam-splitting optical fiber 160, the graded-index optical fiber 170, and/or the coreless optical fiber 180 in the examples shown in FIGS. 3A, 8, 9, and 10 include the same cladding or glass fiber diameter, the single-core optical fiber 120, the multicore optical fiber 140, the beam-splitting optical fiber 160, the graded-index optical fiber 170, and/or the coreless optical fiber 180 may include different cladding or glass fiber diameters. For example, in embodiments, at least one of the single-core optical fiber 120, the multicore optical fiber 140, the beam-splitting optical fiber 160, the graded-index optical fiber 170, and/or the coreless optical fiber 180 may include a cladding diameter different from the cladding diameter of at least another one of the cladding diameters of the single-core optical fiber 120, multicore optical fiber 140, the beam-splitting optical fiber 160, the graded-index optical fiber 170, and/or the coreless optical fiber 180. For example, in embodiments, the diameter of at least one of the graded-index optical fiber 170 and/or the diameter of the coreless optical fiber 180 may be greater than the diameter of the single-core optical fiber 120, the multicore optical fiber 140, and/or the beam-splitting optical fiber 160.

### Advantages

Using the power splitter 100 described herein, many benefits and advantages can be achieved. For example, the power splitter 100 described herein may offer remarkably low insertion loss. In embodiments, the insertion loss of the power splitter 100 described herein may be less than or equal to (i.e., ≤) 1 dB, ≤0.8 dB, ≤0.6 dB, ≤0.5 dB, ≤0.4 dB, ≤0.3 dB, ≤0.2 dB, ≤0.1 dB, ≤0.08 dB, ≤0.06 dB, ≤0.04 dB, ≤0.03 dB, or less. Additionally, the low loss of the power splitter 100 may be achieved over a broad wavelength range. For example, the low loss of the power splitter 100 may be achieved for wavelengths greater than or equal to (i.e., ≥) 400 nm and less than or equal to (i.e., ≤) 2000 nm-including all sub-ranges or values therebetween. The level of efficiency achieved by the power splitter described herein can be significant in submarine optical networks where minimizing optical loss is essential. For example, minimizing pump power loss may contribute to maximizing overall power efficiency in power-constrained submarine cables.

Additionally, the integration of a graded-index optical fiber 170 and/or a coreless optical fiber 180 may allow the power splitter 100 described herein to adapt to a wide range of multicore optical fibers 140. Further, the power splitter 100 described herein can accommodate different operating wavelengths and/or different input single-core optical fibers 120 having diverse core diameters and/or numerical apertures. Such flexibility enhances the versatility of the power splitter 100 described herein in various optical network configurations. Moreover, by avoiding the need for custom-tailored beam-splitting optical fiber 160 for different multicore optical fibers 140, the power splitter 100 described herein can potentially reduce manufacturing costs and simplify the production process of optical components.

Furthermore, the power splitter 100 described herein can ensure uniform power distribution among the cores of the multicore optical fiber 140, with less than 10% of power distribution variation among cores, which further facilitate the reliable operation of optical networks. The power distribution variance among the cores 141 of the multicore optical fiber 140 is defined as follows:

$$Power Distribution Variance ( \% ) = \frac{Max ( power values of all cores ) - Min ( power values of all cores )}{Max ( power values of all cores )}$$

In embodiments, the power distribution variance among the cores 141 of the multicore optical fiber 140 of the power splitter 100 described herein may be less than or equal to (i.e., ≤) 10%, ≤9%, ≤8%, ≤7%, ≤6%, ≤5%, ≤4%, ≤3%, ≤2%, ≤1%, or less.

### Application in Transmission Systems

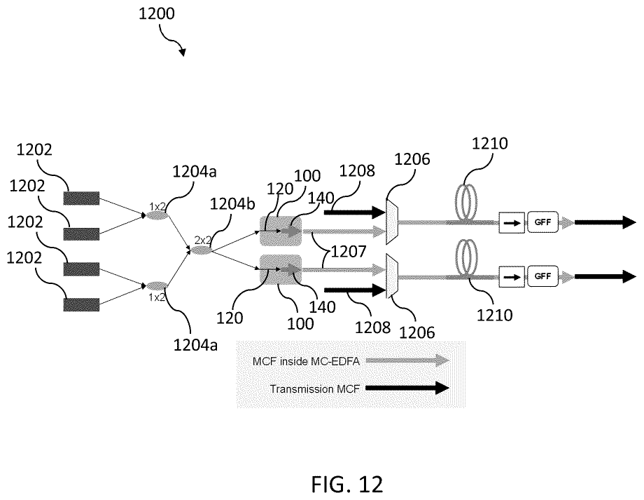

The power splitter 100 described herein may be used for optical fiber transmission systems where multicore fiber amplifiers may be employed for simultaneous amplification of multiple cores, such as in submarine cable repeaters. FIG. 12 schematically illustrates an exemplary system 1200, such as a repeater, using multicore fiber amplifiers, such as multicore erbium-doped fiber amplifiers (MC-EDFAs), and the power splitter 100 described herein with pump farming (pump sharing).

The system 1200 may include two or more pump lasers 1202. The pump lasers 1202 may be coupled to one or more the power splitters 100 described herein, more specifically, coupled to the input single-core optical fibers 120 of the power splitters 100, via one or more power couplers 1204. The coupling between each pump laser 1202 and a power coupler 1204 may be achieved by splicing the output end of the pump laser 1202 and the input end of the power coupler 1204. The coupling between each power splitter 100 and a power coupler 1204 may be achieved by splicing the input end of the single-core optical fiber 120 of the power splitter 100 and the output end of the power coupler 1204.

Each of the power splitter 100 may be coupled to a wavelength division multiplexer (WDM) 1206. The coupling between the power splitter 100 and the WDM 1206 may be achieved by splicing the output end of the multicore optical fiber 140 of the power splitter 100 and the input end of a multicore optical fiber 1207 of the WDM 1206. The WDM 1206 may be configured for combing the power output from the multicore optical fiber 140 of the power splitter 100 and the signal to be amplified, which may be carried over a transmission multicore optical fiber 1208 and subsequently amplified by a doped multicore optical fiber 1210, such as an erbium-doped multicore optical fiber, of a multicore fiber amplifier. In embodiments, the multicore optical fiber 140 of the power splitter 100 may include the same number of cores as the doped multicore optical fiber 1210, the transmission multicore optical fiber 1208, and/or the input multicore optical fiber 1207 of the WDM 1206.

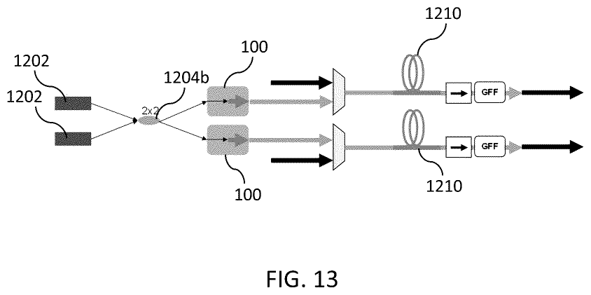

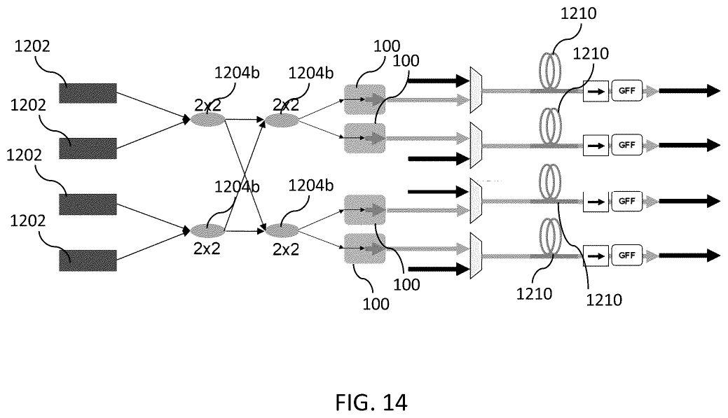

While FIG. 12 illustrates four pump lasers 1202 configured for pumping two doped multicore optical fibers 1210 that share the four pump lasers 1202, any suitable number of pump lasers 1202 may be shared by any suitable number of doped multicore optical fibers 1210 using the power splitters 100 described herein and appropriate coupling configuration between the pump lasers 1202 and the power splitters 100. For example, in the example shown in FIG. 12 where four pump lasers 1202 are configured for pumping two doped multicore optical fibers 1210 via two power splitters 100, each pair of pump lasers 1202 may be coupled to a 1×2 power coupler 1204a, which may then be further coupled to a 2×2 power coupler 1204b for coupling to the power splitters 100. As another example shown in FIG. 13 where two pump lasers 1202 are configured for pumping two doped multicore optical fibers 1210 via two power splitters 100, the single pair of pump lasers 1202 may be coupled to each of the two power splitters 100 via a 2×2 power coupler 1204b. As a further example shown in FIG. 14 where four pump lasers 1202 are configured for pumping four doped multicore optical fibers 1210 via four power splitters 100, each pair of pump lasers 1202 may be coupled to a 2×2 power coupler 1204b, which may then be further coupled to two 2×2 power couplers 1204b each of which may be coupled to two of the four power splitters 100. The examples shown in FIGS. 12 and 14 are non-limiting and for illustrative purposes only. Any other suitable configuration for coupling the pump lasers 1202 to the power splitters 100 and further to the doped multicore optical fibers 1210 may be utilized as would be appreciated by one skilled in the art.

The power splitters described herein allow for simultaneous amplification of multiple cores utilizing multicore fiber amplifiers. By utilizing the power splitters described herein, the coupler network architectures (or configuration of the power couplers) for coupling the shared pump lasers to the power splitter(s) are simpler than those that would be required for the same number of pump lasers pumping individual single-core optical fibers (e.g., 8 individual single-core optical fibers or 16 individual single-core optical fibers) instead of pumping multicore optical fibers (e.g., 2 four-core multicore optical fibers or 4 four-core multicore optical fibers). Additionally, by splitting the power from one pump laser into multiple cores, the power splitter described herein allow power from one pump laser to be shared by multiple cores, allowing for a more cost-efficient and more energy-efficient design to be implemented.

### EXAMPLES

The embodiments described herein will be further clarified by the following additional examples.

Exemplary power splitters each having a structure similar to that shown in FIG. 3A were produced. The exemplary power splitters were made using fibers with the same parameters as those used for simulation shown in FIGS. 4A and 4B, except for the varying fiber length LBs of the beam-splitting optical fiber.

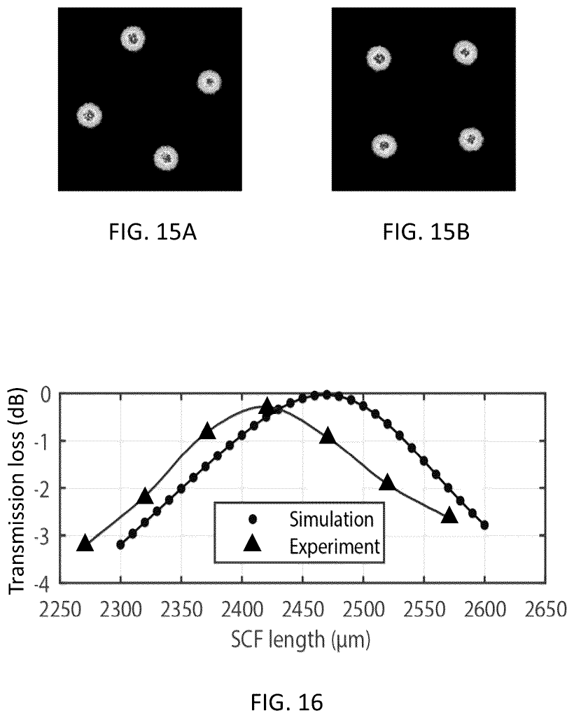

FIG. 15A is a CCD (charge-coupled device) image showing the multimode interference beam pattern at the output end of the beam-splitting optical fiber having a fiber length LBs of 2470 μm. The image of FIG. 15A was taken before splicing the beam-splitting optical fiber to the multicore optical fiber. FIG. 15B is a CCD image showing the output beams at the output end of the multicore optical fiber. Substantially the same power distribution was observed at both the output end of the beam-splitting optical fiber and the output end of the multicore optical fiber. Further, low power variation (less than 10%) among the beam spots of the multimode interference beam pattern, as well as low power variation (less than 10%) among the cores 141 of the multicore optical fiber 140, was achieved.

FIG. 16 plots both simulated and experimental results of the insertion loss (=|transmission loss|) as a function of the fiber length LBs of the beam-splitting optical fiber. Both the simulated and experimental results demonstrate that the power splitters described herein, when configured with appropriate fiber length LBs, can achieve low insertion loss (≤1 dB), with the lowest insertion loss of 0.03 dB observed at the fiber length LBs of 2470 μm based on the simulated result, and the lowest insertion loss of 0.3 dB observed at the fiber length LBs of 2420 μm based on the experimental result.

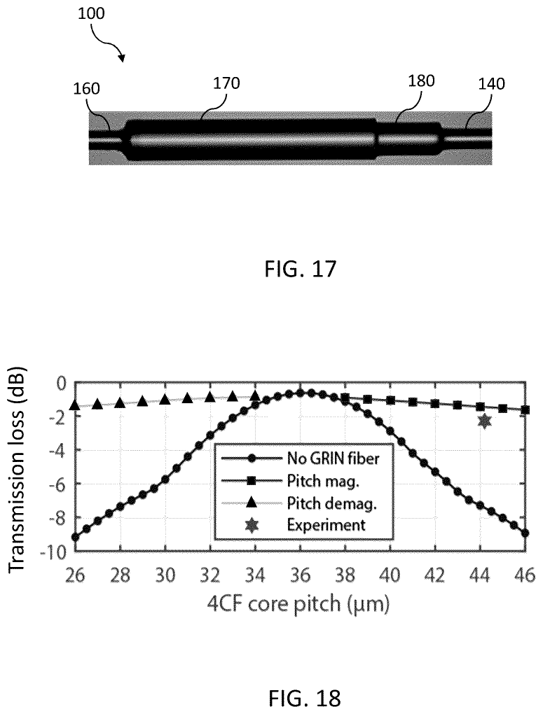

FIG. 17 is a microscopic image of a fabricated power splitter 100. The power splitter 100 includes a single-core optical fiber 120 (not shown in FIG. 17), a beam-splitting optical fiber 160 coupled to the output end of the single-core optical fiber 120, a graded-index optical fiber 170 coupled to the output end of the beam-splitting optical fiber 160, a coreless optical fiber 180 coupled to the output end of the graded-index optical fiber 170, and the multicore optical fiber 140 coupled to the output end of the coreless optical fiber 180. The graded-index optical fiber 170 and the coreless optical fiber 180 are configured to magnify the distance between neighboring beam spots of the multimode interference beam pattern output from the beam-splitting optical fiber 160 to accommodate a larger core pitch of the multicore optical fiber 140.

FIG. 18 plots the transmission losses (transition loss=−insertion loss, and insertion loss=|transmission loss|) of power splitters with and without the graded-index optical fiber 170 as a function of core pitch. For the various simulated and measured results shown in FIG. 18, the same single-core optical fiber 120 and beam-splitting optical fiber 160 (more specifically, a square-core, beam-splitting optical fiber 160) are used, and thus, the same multimode interference beam pattern is output from the beam-splitting optical fiber 160. As shown in FIG. 18, utilizing the graded-index optical fiber 170 to magnify or demagnify the distance between neighboring beam spots of the multimode interference beam pattern, the same beam-splitting optical fiber 160 can be used with multicore optical fibers 140 having various core pitch values ranging from 26 μm to 46 μm. The loss reduction by using the graded-index-fiber-assisted approach is prominent for mismatched beam-splitting optical fiber 160 and multicore optical fiber 140.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A power splitter, comprising:
a single-core optical fiber comprising:
a core;
an input end; and
an output end;
a beam-splitting optical fiber comprising:
a polygonal core configured to output a multimode interference beam pattern comprising a plurality of beam spots;
an input end coupled to the output end of the single-core optical fiber; and
an output end;
a graded-index optical fiber comprising:
a graded-index core;
an input end; and
an output end;
a coreless optical fiber comprising:
an input end; and
an output end; and
a multicore optical fiber comprising:
a plurality of cores;
an input end; and
an output end;
wherein:
the input end of one of the graded-index optical fiber or the coreless optical fiber is coupled to the output end of the beam-splitting optical fiber;
the output end of the other one of the graded-index optical fiber or the coreless optical fiber is coupled to the input end of the multicore optical fiber; and
the graded-index optical fiber and the coreless optical fiber are configured for outputting a multimode interference beam pattern comprising a plurality of beam spots, wherein when the power splitter is in operation, a distance between neighboring beam spots of the multimode interference beam pattern output by the beam-splitting optical fiber is different from a distance between neighboring beam spots of the multimode interference beam pattern output by the graded-index optical fiber and the coreless optical fiber.

2. The power splitter of claim 1, wherein the distance between the neighboring beam spots of the multimode interference beam pattern output from the beam-splitting optical fiber is different from a core pitch of the plurality of cores of the multicore optical fiber.

3. The power splitter of claim 1, wherein when the power splitter is in operation, the power splitter exhibits at least one of the following:
an insertion loss of the power splitter is less than or equal to 1 dB; or
a power distribution variance among the plurality of cores of the multicore optical fiber is less than or equal to 10%.

4. The power splitter of claim 1, wherein a difference between a mode field diameter of the plurality of cores of the multicore optical fiber and a mode field diameter of the core of the single-core optical fiber is less than or equal to 50%.

5. The power splitter of claim 1, wherein:
the input end of the graded-index optical fiber is coupled to the output end of the beam-splitting optical fiber;
the input end of the coreless optical fiber is coupled to the output end of the graded-index optical fiber; and
the input end of the multicore optical fiber is coupled to the output end of the coreless optical fiber.

6. The power splitter of claim 5, wherein when the power splitter is in operation, the distance between the neighboring beam spots of the multimode interference beam pattern at the output end of the coreless optical fiber is greater than the distance between the neighboring beam spots of the multimode interference beam pattern at the output end of the beam-splitting optical fiber.

7. The power splitter of claim 1, wherein:
the input end of the coreless optical fiber is coupled to the output end of the beam-splitting optical fiber;
the input end of the graded-index optical fiber is coupled to the output end of the coreless optical fiber; and
the input end of the multicore optical fiber is coupled to the output end of the graded-index optical fiber.

8. The power splitter of claim 7, wherein when the power splitter is in operation, the distance between the neighboring beam spots of the multimode interference beam pattern at the output end of the graded-index optical fiber is less than the distance between the neighboring beam spots of the multimode interference beam pattern at the output end of the beam-splitting optical fiber.

9. The power splitter of claim 1, wherein:
corners of the polygonal core are disposed at a radial distance r_{pc} from a fiber axis CL_{BS} of the beam-splitting optical fiber; and
a diameter of the graded-index core of the graded-index optical fiber is greater than or equal to at least one of 2×r_{pc} or an edge width w_{pc} of the polygonal core.

10. The power splitter of claim 1, wherein:
the polygonal core comprises a square core;
the multimode interference beam pattern comprises an n×n multimode interference beam pattern; and
the beam-splitting optical fiber is configured with a length for generating the n×n multimode interference beam pattern at the output end of the beam-splitting optical fiber.

11. The power splitter of claim 1, wherein the single-core optical fiber is a single mode fiber.

12. The power splitter of claim 1, wherein an operating wavelength of the power splitter is greater than or equal to 400 nm and less than or equal to 2000 nm.

13. A repeater, comprising at least one power splitter of claim 1.

14. The repeater of claim 13, further comprising:
at least one power amplifier coupled to the at least one power splitter, wherein:
the at least one power amplifier comprises a multicore fiber amplifier;
the at least one power amplifier comprises a doped multicore optical fiber; and
the doped multicore optical fiber and the multicore optical fiber of at least one power splitter of the plurality of power splitters include the same number of cores.

15. A power splitter, comprising:
a single-core optical fiber comprising:
a core;
an input end; and
an output end;
a beam-splitting optical fiber comprising:
a polygonal core configured to output a multimode interference beam pattern comprising a plurality of beam spots;
an input end coupled to the output end of the single-core optical fiber; and
an output end; and
a multicore optical fiber comprising:
a plurality of cores;
an input end coupled to the output end of the beam-splitting optical fiber; and
an output end;
wherein the power splitter is configured such that at least one of the following is satisfied:
a difference between a mode field diameter of the plurality of cores of the multicore optical fiber and a mode field diameter of the core of the single-core optical fiber is less than or equal to 50%; or
when the power splitter is in operation, a difference between a distance between neighboring beam spots of the multimode interference beam pattern output by the beam-splitting optical fiber and a core pitch of the plurality of cores of the multicore optical fiber is less than or equal to 10%;
wherein when the power splitter is in operation, the power splitter further exhibits at least one of the following:
an insertion loss of the power splitter is less than or equal to 1 dB; or
a power distribution variance among the plurality of cores of the multicore optical fiber is less than or equal to 10%.

16. The power splitter of claim 15, wherein:
the polygonal core comprises a square core;
the multimode interference beam pattern comprises an n×n multimode interference beam pattern; and
the beam-splitting optical fiber is configured with a length for generating the n×n multimode interference beam pattern at the output end of the beam-splitting optical fiber.

17. The power splitter of claim 15, wherein the single-core optical fiber is a single mode fiber.

18. The power splitter of claim 15, wherein an operating wavelength of the power splitter is greater than or equal to 400 nm and less than or equal to 2000 nm.

19. A repeater, comprising at least one power splitter of claim 15.

20. The repeater of claim 19, further comprising:
at least one power amplifier coupled to the at least one power splitter, wherein:
the at least one power amplifier comprises a multicore fiber amplifier;
the at least one power amplifier comprises a doped multicore optical fiber; and
the doped multicore optical fiber and the multicore optical fiber of at least one power splitter of the plurality of power splitters include the same number of cores.
